(19) United States
(12) Patent Application Publication
(10) Pub. No.: US 2004/0249501 A1
(43) Pub. Date: Dec. 9, 2004

(54) Enhanced bill acceptor/dispenser for vending machines

(76) Inventors: Peter E. Hand, Las Vegas, NV (US); Joshua Corrick, Henderson, NV (US); Raymond Heidel, Henderson, NV (US)

Correspondence Address: David B. Abel, Esq., SQUIRE, SANDERS & DEMPSEY. LLP, 14th Floor, 801 South Figueroa, Los Angeles, CA, 90017, US

(21) Appl. No.: 10/814,390

(22) Filed: Mar. 30, 2004

Related U.S. Application Data
(63) Continuation-in-part of application No. 09/722,856, filed on Nov. 27, 2000, now Pat. No. 6,742,644.

(51) Int. Cl. G07F 7/04; G06K 7/00; G07D 7/00; G06K 9/00; G06F 7/00; G06F 9/00; G07F 9/08; G06F 19/00; G06F 17/00

(52) U.S. Cl. 700/231; 194/206; 194/207; 194/217

(57) ABSTRACT

A system which will allow a bill acceptor and dispenser to be incorporated into a vending machine operating on a standardized vending machine protocol to allow the vending machine to dispense change in the form of coins and/or currency according to the amount of change to be dispensed and the availability of specific denominations of coins and currency.

This application is a continuation-in-part of U.S. application Ser. No. 09/722,856 filed Nov. 27, 2000, hereby incorporated by reference.

### BACKGROUND OF THE INVENTION

1. Field of the Invention

The present invention is generally directed to the field of vending machines and in particular to vending machines utilizing standardized control systems and a money handling system into which a bill acceptor-dispenser is incorporated to allow the vending machine to accept notes and provide currency or coins as change. The bill acceptor-dispenser also provides enhanced data processing capabilities to increase the control of the allowable transactions. The present invention is further directed to a bill acceptor-dispenser capable of analyzing denominations of bills exceeding $5 in value and evaluating the capacity of the money handling system's ability to provide adequate change to the user of a vending machine and communicate the status of the money handling system to both the user and the vending machine's control system.

2. General Background and State of the Art

Vending machines are in widespread use for the convenient dispensing of small, low cost items like drinks, candy, snacks and tobacco products. Originally, vending machines were coin only machines having the ability to accept and validate coins and a limited ability to make change. The development of currency or bill validating devices allowed the incorporation of such devices into coin operated vending machines, allowing a vending machine to accept selected denominations of paper currency and credit the face value of the currency for allowing purchase of an item. Once an item for purchase is selected, any remaining credit is generally dispensed as change in coins.

To allow the incorporation of bill acceptors into vending machines, a standardized data protocol has been developed and adopted by The National Automatic Merchandising Association, NAMA®, in cooperation with the European Vending Association. A “Multi-Drop Bus/Interface Communication Protocol (MDB/ICP) Standard, Version 3.0 was adopted by NAMA® in March 2003. This standard allows a bill validator to communicate with the vending machine controller (“VMC”), generally a microprocessor, and the VMC to communicate with the coin accepting device or changer.

However, the incorporation of bill acceptors in vending machines created a situation where users would more commonly use bills as opposed to coins to make purchases, resulting in bills being accepted and coins being dispensed without the coin collection tubes of the coin changer being replenished by coins input by the customers. This may result in an increase in the number of service calls required to replenish the coins in the coin changer while bills are removed from the bill acceptor. The depletion of even one specific coin denomination could result in the need for a service call or the inability to vend certain items as the VMC prevents a vending machine from dispensing an item if correct change can not be provided.

Thus, a need arose to try and manage the selection of coin denominations to be dispensed as change to attempt to minimize service calls. For example, U.S. Pat. No. 6,045,443 issued to Weston et al. discloses a method and apparatus for controlling the dispensing of coins as change from a vending machine. The method determines a combination of coins to be dispensed as change by determining a plurality of different possible combinations and selecting the most favorable one to conserve the remaining coins. The most favorable combination is the one determined to leave the greatest number of coins available for change according to a predetermined criterion that takes into account the number of currently available coins. This solution may forestall, but not eliminate, the problems associated with rapid depletion of the coins available to provide change in a vending machine which includes a bill acceptor.

The development of bill accepting machines which would also allow the dispensing of bills as change, a bill acceptor-dispenser, allowed systems to be developed for vending machines that would take in either currency or coins, allow the selection of a purchase item, and the dispensing of change in the form of currency and/or coins. Sophisticated systems have been developed to control such integrated systems, as discussed for example in U.S. Pat. No. 4,499,982 issued to Sugimoto et al., which discloses a vend judgment device for an integrated vending machine assembly. The vend judgment device keeps track of the number of each denomination of coin and bill accepted by the machine, and each are stored in respective storage boxes within the machine. When a deposit is made, the vend judgment device counts up the number of deposited coins and bills in their respective denominations and counts down the number of paid out coins and bills in their respective denominations when change is made. The vend judgment device determines whether an item may be dispensed from the vending machine by calculating whether proper change may be dispensed from the vending machine. However, separately storing each denomination of bill in the vending machine makes this system both space intensive and substantially increases the number of components to transport the bills to their respective stacker, which compounds the potential note jam points which may require servicing. The space intensive requirement of this type of system is particularly problematic as the vending machine operator prefers a machine which maximizes the space available to store the products to be sold, not empty space required to hold potential currencies which may or may not be received.

The development of convenience devices which accept higher denominations of currency to allow the purchase of more expensive items, for example gasoline for an automobile, while still allowing the dispensing of currency and/or coins as change was inevitable. U.S. Pat. No. 6,055,521 issued to Ramsey et al. discloses an integrated cash station and change dispensing system to be used at a gas station to accept and dispense currency, or coins, or a combination of both. The '521 patent teaches a cash console that instructs a currency and change dispensing means to dispense an appropriate amount of change to a purchaser upon completion of a transaction. In this regard, the cash console instructs the coin dispenser to dispense appropriate coins to the change drawer and instructs a currency dispenser to dispense an appropriate number of bills to the change drawer. The system according to the Ramsey '521 Patent is not concerned with maximizing the space in a vending machine dedicated to holding product as it is primarily a cash receipt system with an electronic control signal output to a separate dispensing device, a gas pump.

The foregoing described devices of the Sugimoto and Ramsey patents are not suitably designed to be incorporated into vending machines, particularly those utilizing the established vending machine communication protocols. Indeed, the installed base of vending machines have a VMC running a standardized protocol that does not accommodate acceptance of bill denominations greater than $5. A significant number of such machines are installed in locations such as amusement parks where the price point of products in the vending machine is increased to the point that single items may sell for $2 or more. At these higher price points, it becomes more common for users to purchase products with $10 or even $20 bills, the most common denomination dispensed by bank automated teller machines. Accordingly, a need arises for a vending machine money handling system having a bill acceptor-dispenser that will allow the bill acceptor-dispenser to be incorporated into a vending machine operating on a standardized vending machine protocol to allow the vending machine to accept larger denominations of bills and dispense change in the form of coins and/or currency according to the amount of change to be dispensed and the availability of specific denominations of coins and currency.

### INVENTION SUMMARY

The present invention is, in one aspect, directed to a money handling system for a vending machine which includes a bill acceptor-dispenser to be incorporated into a vending machine having a VMC operating on a standardized vending machine protocol to allow the vending machine to accept larger denominations of bills into a bill acceptor-dispenser having an incorporated controller and program that can interface with the VMC and instruct the VMC to dispense change in the form of coins from the coin handling system and the acceptor-dispenser can dispense bills or currency according to the amount of change to be dispensed and the availability of specific denominations of coins and currency. To allow compatibility with existing vending machines operating on NAMA protocol software, the bill acceptor-dispenser incorporates a data processor and software program that can communicate with the VMC and interpret the NAMA instructions to properly control the coin dispenser and display information to a user.

### BRIEF DESCRIPTION OF THE DRAWINGS

FIG. 1 shows a representative vending machine operating on the NAMA protocol including the system incorporating a bill acceptor-dispenser to provide change in the form of currency or coins, as appropriate, according to the present invention;

FIG. 2 shows a perspective view of a bill acceptor-dispenser including the note box and note hopper assembly for use in the present invention;

FIG. 3 illustrates the control system configuration of the bill acceptor-dispenser coupled to the vending machines VMC according to the present invention;

FIG. 4 is a logic diagram showing the bill validation and bill storing/dispensing features of the control system for operating the system according to the present invention;

FIG. 5 is a simplified schematic drawing of the first embodiment of the invention wherein the change instruction from the VMC is directed to the bill acceptor-dispenser;

FIG. 6 is a simplified schematic drawing of a second embodiment of the invention wherein the change instruction from the VMC is directed to the coin acceptor/changer;

FIG. 7 is a logic diagram showing the program for controlling the advanced features of the system of the present invention;

FIG. 8 is a perspective view of a bezel assembly of the bill acceptor-dispenser incorporating an informational display;

FIG. 9 is a perspective view of a further enhanced bezel assembly for the bill acceptor-dispenser;

FIG. 10 is a flow chart of a first subroutine for the Control Program of FIG. 7;

FIG. 11 is a flow chart of a second subroutine for the Control Program of FIG. 7;

FIG. 12 is a flow chart of a third subroutine for the Control Program of FIG. 7;

FIG. 13 is a flow chart of a fourth subroutine for the Control Program of FIG. 7; and

FIG. 14 is a flow chart of a fifth subroutine for the Control Program of FIG. 7.

### DETAILED DESCRIPTION OF THE PREFERRED EMBODIMENTS

The present invention can be used in automated sales machines and pay point machines, where a combination of currency and change may be required to be paid out to customers. For purposes of detailing the invention, however, the description herein is tailored to the primary application of the invention: a vending machine operating under the NAMA protocol and vending machines for dispensing higher price point items. It is to be understood that while a typical can or bottle type of vending machine is depicted and described, the invention is applicable to other types of vending machines.

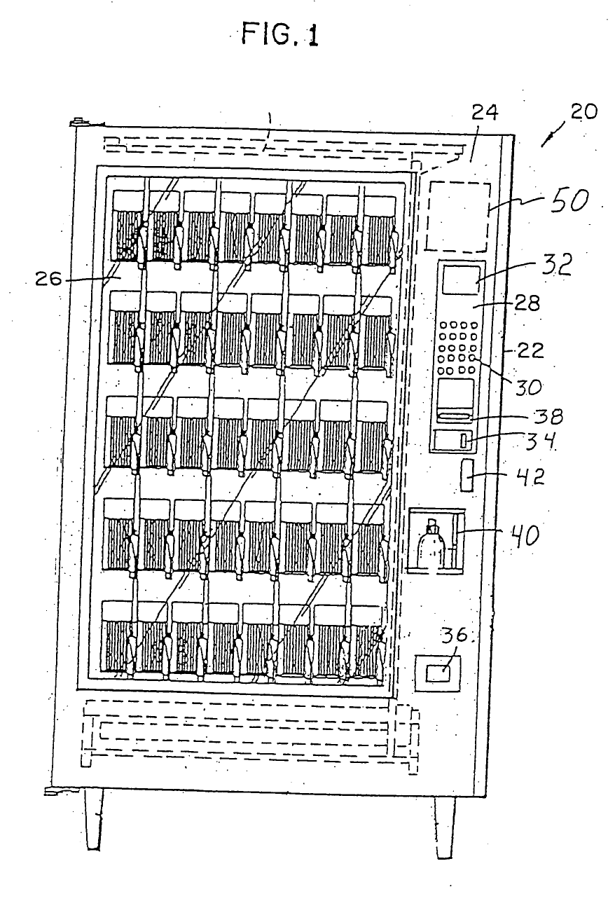

FIG. 1 depicts a vending machine 20 including an outer chassis or cabinet 22 and a front hinged door panel 24, which in combination define an inner cavity for housing the products to be vended, the control and refrigeration (if necessary) functions of the machine and other vending machine features well-known in the art. The front door panel 24 can frame a transparent glass or clear plastic panel 26 which provides a clear view into the internal cavity of the cabinet and the products stored in ordered manner on trays therein when the door panel 24 is closed. The door panel 24 includes an appropriate control panel, generally indicated at 28 which includes a product selection input keypad 30 and monetary and credit processing and display system 32, well-known in the art. Those skilled in the art will readily recognize many appropriate control panels and features thereof that could be used in association with a vending machine as hereinafter described.

The door panel 24 illustrated in FIG. 1 also includes a coin insert slot 34 and a coin return slot 36, associated with a coin acceptor/changer contained behind the door panel 24. In addition, the door panel 24 includes an opening through which projects a bezel assembly 38 of a bill acceptor-dispenser (described below) which is also disposed behind the door panel 24.

The door panel 24 also includes a product delivery port, generally indicated at 40, which is approximately at thigh or waist level and depicted with its door in an “open” position in FIG. 1, with a vended bottle product illustrated through the open door. A locking handle assembly 42 enables the door to be opened and closed in secured manner for purposes of maintenance, loading of the machine, and the like.

The vending machine 20 includes a vending machine controller (VMC) 50 behind the door panel 24. The VMC 50 is responsible for controlling the operation of the vending machine 20. A bill acceptor-dispenser 60 within the vending machine 20 is electrically coupled to the VMC 50 and it is adapted to receive and selectively dispense paper currency as discussed in greater detail below. A coin acceptor/changer within the vending machine 20 is electrically coupled to the VMC 50 and it is adapted to receive, hold and dispense coins or tokens in a known fashion. The VMC 50 typically monitors the deposit of coins or currency, allows the selection of an item to be purchased and the deduction of the purchase price from the credited amount received, and, if necessary, the dispensation of any change to the customer.

To purchase products from a vending machine 20, a customer inserts coins, bills or other currency through the appropriate slot, the authenticity is tested and if valid the amount is determined and accumulated as credits in the VMC 50 for vending selected products. The received coins are directed to the coin acceptor/changer for validation and storage. Alternatively, the customer can insert bills or currency into the bill acceptor-dispenser 60, which receives notes, currency or other legal tender and, based upon the determined value, assigns a corresponding value of credits within the vending machine 20 for vending selected products.

According to the present invention, the bill acceptor-dispenser 60 is disposed in the cabinet 22 of the vending machine 20, and electrically connected to the VMC 50 therein. Preferably, the bill acceptor-dispenser 60 is of a size and configuration to be received within the cabinet 22 at the location previously occupied by prior bill validating devices so that no extensive reconfiguration or redesign of the vending machine 20 is required.

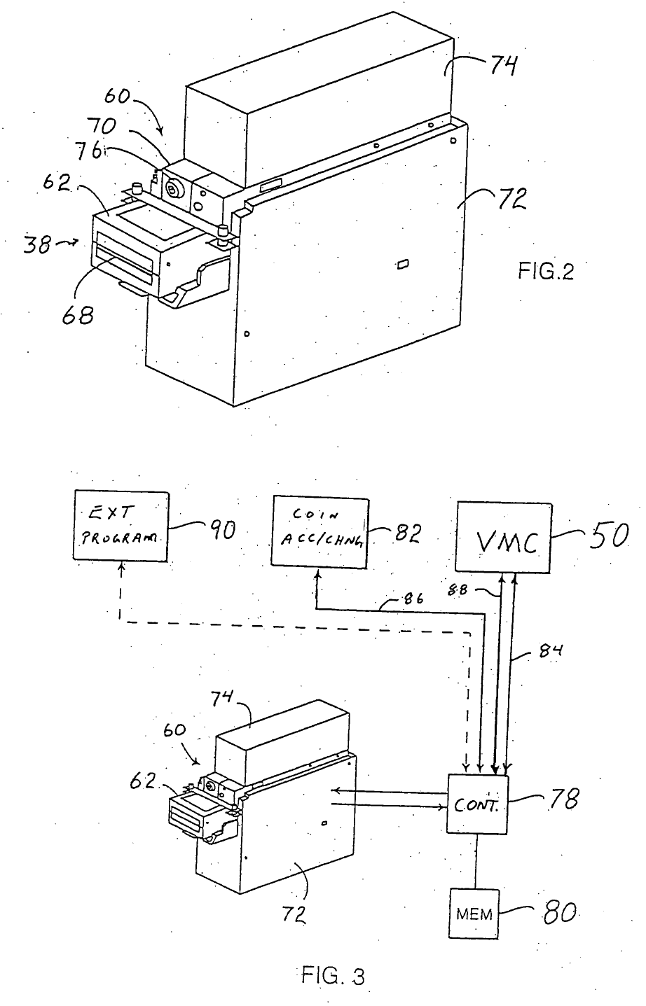

The bill acceptor-dispenser 60, as shown in FIG. 2, includes a validator 62 having a validator head adapted to scan a bill, paper currency or generally a “note” inserted into an opening 68 of the bezel assembly 38 to determine the authenticity, type (of legal tender), denomination and condition (whether the note is worn) of the note. Typically the note is inserted into the opening 68 and is captured and transported by a transportation unit 70 past optical and magnetic sensors which may, for example, sense light reflected by and/or transmitted through the note, reflectivity and transmission patterns, size of the note and the magnetic characteristics of the inserted note. The various sensors output sensed data output signals which are compared by a validator processor to stored data representative of the range of sensor readings corresponding to authentic notes.

If the note is determined valid and authentic, based on the comparison with the stored data for authentic notes, the transportation unit 70 transports the note to one of a note box 72 or a note hopper 74 for storage. Also, upon receipt and determination of validity, a signal is sent to the vending machine's VMC 50 signifying receipt, as well as the denomination, of the note for accumulation of a like value amount of credits in the vending machine 20. If the note is not determined valid, the transportation unit 70 is reversed and the note is ejected through the opening 68 to the customer.

The note box 72 is preferably positioned below, the transportation unit 70, as shown in FIG. 2. The note hopper 74 may be positioned above the transportation unit 70 to take advantage of open space in many existing vending machines, however the note hopper can be stacked above, behind or below the note box 72, both of which may be either above or below the transportation unit 70. The note hopper 74 and note box 72 are secured to the transportation unit 70 to form the bill acceptor-dispenser 60. To prevent theft of notes during service of the vending machine 20, the attachment of the note box 72 may include a locking mechanism 76 which opens the note box 72 to allow receipt of notes from the transportation unit 70 only when the note box 72 is locked to the acceptor-dispenser 60. When the note box 72 is unlocked for removal, the locking mechanism 76 closes the note box 72 to prevent removal of notes stored therein.

The notes received into the note box 72 are typically stacked in a vertical relationship and accordingly the note box 72 has a configuration corresponding to the plan dimensions of the notes. The bill acceptor-dispenser 60 according to the present invention also includes the note hopper 74 adapted to receive and store notes in a stacked relationship.

The transport unit 70 is adapted to move notes through the validator 62 to a selected one of the note box 72 or note hopper 74. To control the transportation unit 70, the bill acceptor-dispenser 60 includes a unit controller 78 (FIG. 3), which is in communication with the validator 62 as well as the vending machine's VMC 50. Motorized means within the transportation unit 70 such as motorized traction wheels, belts, conveyers and gates, under control of the unit controller 78, selectively move the notes accepted as being valid within the bill acceptor-dispenser 60.

The unit controller 78 also includes a data structure or memory 80 (FIG. 3) storing data concerning the notes stored in the note hopper 74 including at least data corresponding to the number of notes stored in the note hopper 74. Similarly, the unit controller 78 and memory 80 preferably have the ability to store data concerning the number and type of notes stored in the note box 72. Moreover, the unit controller 78 and memory 80. associated therewith optimally can also provide status and activity information, including for example dispensing or accepting status, fault conditions, any “note hopper empty” condition, a note hopper or transportation unit jam or a note hopper absence condition. It may also be beneficial to have memory devices, such as contact memory devices known in the art, integral with the note hopper 74 and the note box 72, such memory devices being configured to receive data from the unit controller 78 concerning the status of the notes which should be present in the respective device. All of the data available in the memory 80 may be remotely accessible from the unit controller 78 by the vending machine's VMC 50.

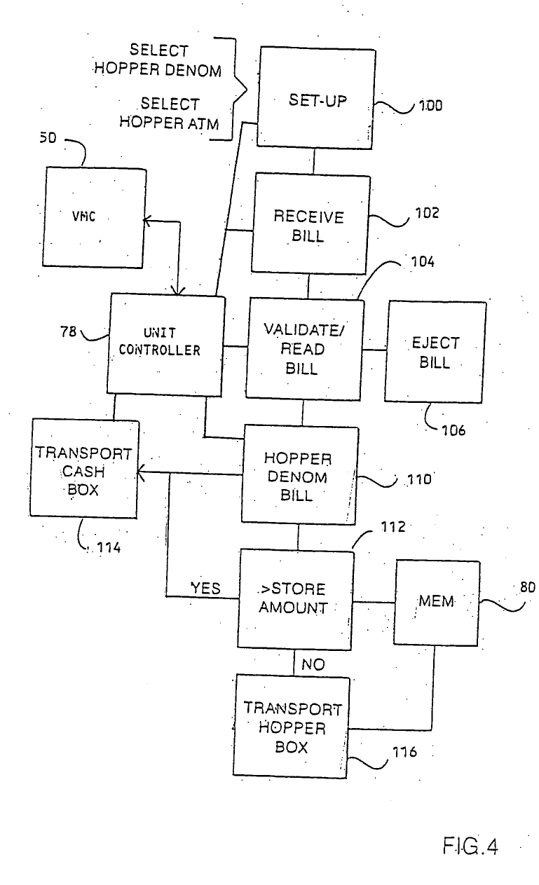

With reference to FIGS. 3 and 4, the logic of the operation of the acceptor-dispenser 60 and method of the present invention is illustrated using block diagrams. The unit controller 78 (FIG. 3) is first configured in the block diagram of FIG. 4 during a set up procedure, shown by box 100, to select the denomination/type of note to be sent to and stored in the note hopper 74 as well as the selected number of notes to be routed to and stored therein. The configuration at set up 100 may be by a command or series of commands from the vending machine's VMC 50 or by a portable, hand-held device to be coupled to and in communication with the unit controller 78 and VMC 50 as shown in FIG. 3. The configuration or set up at 100 of the bill acceptor-dispenser 60 may also include input of data into the memory 80 of data corresponding to the number of notes pre-loaded into the hopper box 74 for dispensing thereof in the manner described below.

As an example of how the bill acceptor-dispenser 60 may be operated, the unit controller 78 may be configured to maintain a store or escrow of at least a minimum of five to fifty notes in the note hopper 74 with a beginning inventory of five to twenty notes. The number, denomination or type of note, minimum note quality and starting inventory can be selectively changed to store another denomination or type, or to store script notes only, store only less worn (i.e. higher quality) notes or any combination thereof. The unit controller 78 may alternatively be programmed to store mixed denominations of bills in the note hopper 74, for example $1 and $5 bills, in preset or random sequences. These instructions, may be downloaded from the VMC 50, if it has the capacity to do so, or by a portable controller 90, as shown in FIG. 3.

Once instructed, the unit controller 78 controls the transportation unit 70 to deliver newly received notes accepted by the validator and meeting the preset criteria to the note hopper 74, until instructed otherwise. For example, the unit controller 78 may be instructed to store a minimum of one hundred notes and up to a maximum of four hundred notes. Additionally, the note hopper 74 may be loaded with an inventory of notes. The notes in the note hopper 74 are the only notes which may be dispensed as change.

To purchase an item from the vending machine 20, a customer inserts a note (step 102) into the validator opening 68. The note is transported through the validator 62 to scan the note. Data from the validator's sensors is transmitted to the unit controller 78, which, at step 104, compares the data to stored data to determine the note's authenticity, denomination, type and condition. If the note is not determined to be authentic, unit controller 78 rejects the note at step 106 and controls the transportation unit 70 to reverse the direction of the drive transport and thereby expel the note through the validator opening 68 and back to the customer. If the note is determined to be authentic, the denomination or value of the note is transmitted by the unit controller 78 to the VMC 50. Alternatively, for denominations of notes exceeding $1 or $5, the unit controller 78 may only transmit a valuation of $1 or $5 to the VMC 50 and the unit controller 78 retains responsibility for dispensing change exceeding the amount of change to be dispensed that the VMC 50 has the capacity to calculate. The VMC 50 establishes a corresponding value amount of credits in the vending machine 10 to allow the customer to make a selection and displays the amount on the display system 32 of FIG. 1. The unit controller 78 may also control the display system 32 as well as a display positioned on the bezel assembly 38 that provides for example an indication of the denomination of received bills.

The data for the note is also compared within the unit controller 78 to determine at 110 if the note is of a type, denomination and condition or quality selected for storage in the note hopper 74. If it is, the unit controller 78 at step 112 further interrogates the memory 80 to determine if the maximum storage number of notes to be stored in the note hopper 74 has been met. If the number of notes in the note hopper 74 is less than the instructed maximum number, the note is routed to the note hopper 74 at step 116. If the maximum number of notes in the note hopper 74 has already been stored in the note hopper 74, the unit controller 78 controls the transportation unit 70 to transport the received note at step 114 to the note box 72.

When a note is transported to the note hopper 74, the memory 80 is updated to indicate that a note has been added to the note hopper 74. Thus, the memory 80 keeps a running total of the number of notes stored in the note hopper 74 to preferentially maintain a pre-selected number of notes to be stored therein. Additionally, when mixed note denominations are stored in the note hopper 74, the memory 80 may keep track of the denomination of each sequentially stored note. When a pre-selected maximum number or valuation of notes to be stored in the note hopper 74 has been met, additional notes, even though they may be of the denomination, type and condition which would normally be stored in the note hopper 74, are sent to the note box 72 for storage. If the validated note is not of the pre-selected type to be stored in the note hopper 74 the transportation unit 70 is instructed at step 114 to send the note to the note box 72.

When a customer completes a transaction or wishes to cancel the transaction to have the accumulated credits refunded, an appropriate instruction is sent to or received from the vending machine's VMC 50. If the VMC 50 is limited in its capacity to calculate change, then the unit controller 78 only instructs the VMC 50 of the amount received up to the capacity of the VMC 50. The VMC 50 generally calculates the amount of the change to be dispensed and sends out a dispense signal. For vending machines having a “level 2” coin acceptor/changer 82, the dispense signal indicates the coin type(s) and number(s) of each coin to be dispensed. For “level 3” coin acceptor/changers 82, the VMC 50 may simply provide an instruction on line 84 directed to the coin acceptor/changer 82 of the amount of the payout anticipating that the coin acceptor/changer will determine a proper combination for the coin payout.

In the system according to the present invention, the signal on line 84 from the VMC 50 to the coin acceptor/changer is preferably routed to the unit controller 78 of the bill acceptor-dispenser 60. Therein, the unit controller 78 determines if the signal is a level 2 or level 3 instruction, establishes the amount of the payout instruction, and determines if the payout should be made at least in part by dispensing one or more bills from the note hopper 74.

If the amount of the payout is less than the stored note denomination, the instruction is passed from the unit controller 78 to the coin acceptor/changer 82 on line 86 and the payout is made exclusively by the coin acceptor/changer to the customer. If the payout can be made utilizing the stored denomination notes, then the unit controller 78 will direct the bill acceptor-dispenser 60 to pay out notes from the note hopper 74 as change, in combination with coins dispensed by the coin changer, if appropriate.

For example, where the vending machine 20 is a minimum five cent unit machine, the denomination of notes stored in the note hopper 74 is one dollar notes and the payout is greater than twenty units, the calculation is made by the unit controller 78 of bill acceptor-dispenser 60 and the appropriate combination of notes is dispensed from the note hopper 74. Any remaining payout in an amount less than the denomination of the notes in the note hopper 74 to satisfy the remainder of the payout is sent to the coin acceptor/changer 82. The bill acceptor-dispenser's unit controller 78 thus receives or intercepts the signal from the VMC 50 and controls the coin acceptor/changer 82 to dispense the requisite number of coins derived from the calculation for the payout and sends an instruction to control the transportation unit 70 to sequentially retrieve one or more notes from the note hopper 74 for dispensing.

Under instruction from the unit controller 78, the transportation unit 70 serially retrieves and transports the required number of notes from the note hopper 74 through the validator head 66 for dispensing through the opening 68 for the payout. In this process, as a note is dispensed, the validator head 66 senses the note and sends a signal to the unit controller 78 and memory 80 to account for the dispensing of the note for the payout. To prevent notes from stacking one behind the other, the validator head 66 may also sense the removal of the note from the opening 68 by the customer before an instruction is sent to the unit controller 78 to dispense another note. As notes are dispensed, the memory 80 is updated and the number and value of dispensed notes is deducted. Thus the memory 80 keeps a running tally of notes stored in the note hopper 74. Further, as notes are dispensed, a signal is sent to the vending machine's VMC 50 on line 88 to account for the dispensing of notes and coin/tokens until the payout is complete.

The note acceptor-dispenser may also be capable of scanning notes being withdrawn from the note hopper 74 before the note is dispensed. Accordingly, each note to be dispensed can be verified prior to being ejected through opening 68. Further, in particular for systems capable or programmed to store multiple note denominations in the note hopper 74, notes can be withdrawn from the note hopper 74, scanned to determine denomination, and when a denomination is detected that should not be provided as change, the transportation unit transports the bill to the note box 72 and then extracts the next stored note from the note hopper 74 to determine if it is of the proper or selected denomination. This sequence occurs until the payout or change dispense function is completed. Each time a note is removed from the note hopper 74, the memory 80 is updated.

The bill acceptor-dispenser 60 preferably has the capability of monitoring the number of notes in the note hopper 74, the status of the note hopper 74 and the status of the transportation unit 70. Thus, the system can determine or detect when all notes are depleted from the note hopper 74 and any jamming of notes in the note hopper 74 or transportation unit 70. It may be beneficial to include a security protocol, for example a password or encryption system, to limit access to the unit controller's program so that the system cannot be changed so as to store or dispense a different denomination of note from the note hopper 74 absent proper authorization. As another security feature, the unit controller 78 can be programmed so as to preclude any change being made to the denomination of note to be directed to the note hopper 74 if there are any notes in the note hopper 74. Further, the unit controller 78 is preferably programmed to allow control over the maximum number of notes dispensed on a payout and the maximum number of notes that can be dispensed in a specified amount of time.

As an example of an alternative embodiment of the contemplated invention which would be readily apparent to those skilled in the art following review of the foregoing detailed description, the notes dispensed by the bill acceptor-dispenser 60 may be provided through a second opening, distinct and spaced apart from the opening 68 which receives notes to be scanned by the validator 62. Such an arrangement would have the benefit of decreasing the wear on the validator. Accordingly, when a note is to be dispensed, the transportation unit would transport the note to the second opening for example coupled with the coin return slot 36, for dispensing to a customer.

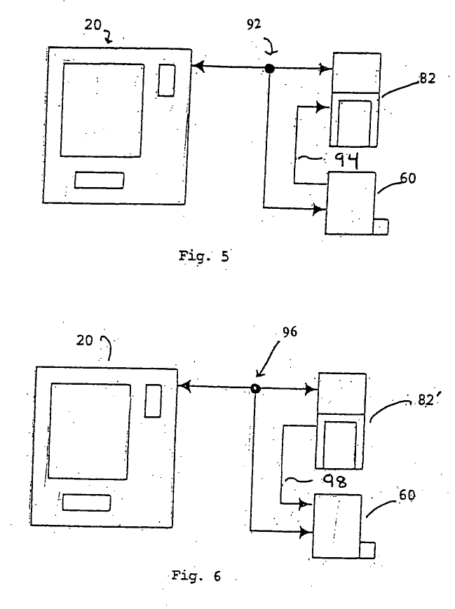

FIGS. 5 and 6 are provided to depict in simplified schematic drawings the implementation of the invention into a vending machine. In FIGS. 5 and 6, the vending machine 20 includes the coin acceptor/changer 82 and the bill acceptor-dispenser 60 which replaces the prior art bill acceptors which were not capable of dispensing notes.

In FIG. 5, a wiring harness 92 interconnects the VMC 50 of the vending machine 20 to the bill acceptor-dispenser 60 and the coin acceptor/changer 82. In the wiring harness 92, the output signal from the VMC 50 directed to the coin acceptor/changer 82 is routed to the bill acceptor-dispenser 60. A connection 94 from the bill acceptor-dispenser 60 to the coin acceptor/changer 82 provides the path by which the coin acceptor/changer 82 is instructed to dispense coins as change.

In FIG. 6, by comparison, a wiring harness 96 interconnects the VMC 50 of the vending machine 20 to the bill acceptor-dispenser 60 and the coin acceptor/changer 82. In the wiring harness 96, the output signal from the VMC 50 is directed to the coin acceptor/changer 82, as is the case in prior art systems according to the NAMA protocol. The coin acceptor/changer 82′ of this embodiment, however, would be upgraded to allow it to output a signal to the bill acceptor-dispenser via path 98 with an instruction to dispense one or more notes from the note hopper as change. In this configuration, the coin acceptor/changer 82′ would report the coin inventory and change output to the VMC 50 after each transaction.

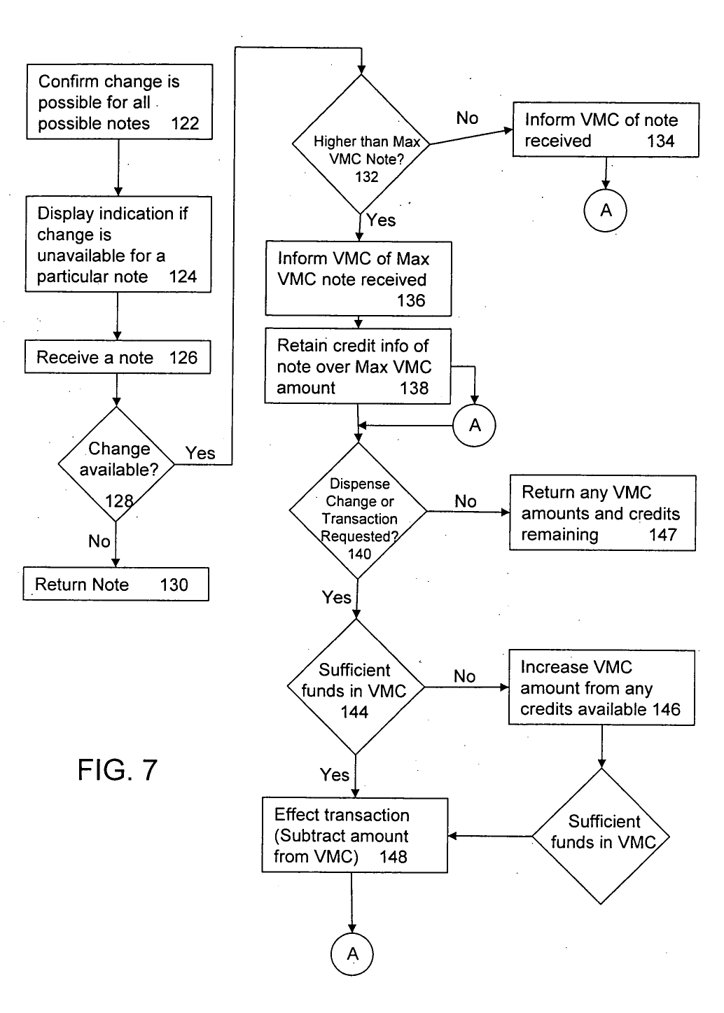

FIG. 7 provides a flow chart for the Control Program 120 implemented into the vending machine 20, preferably within unit controller 78 of the bill acceptor-dispenser 60, to control communications with the VMC 50 and the coin acceptor/changer 82 to accommodate bill denominations in excess of $1 or $5. The Control Program 120 is configured to operate with the NAMA protocol, and existing VMCs, which generally are not capable of receiving an input of an accepted bill denomination greater than $5.

As depicted in the flow chart of FIG. 7, the Control Program 120 initiates with an inquiry to the unit controller 78 and memory 80 to confirm what change is available to be dispensed for all-possible notes at step 122. At step 124, the Control Program 120 signals the display indicators (discussed below) to illuminate the displays for the bills that can be accepted and for which change is available. At this point, the Control Program 120 waits for a signal at step 126 indicative of the denomination of a bill being received by the bill acceptor-dispenser 60. The Control Program 120 determines if change can be made at step 128. If sufficient change is not available, a return note signal 130 is sent to the unit controller 78 and the bill is ejected. If sufficient change is available, the Control Program 120 determines if the denomination of the bill is higher that the maximum denomination that the VMC 50 can accommodate at step 132. If the denomination of the bill does not exceed the capacity of the VMC 50, a signal is sent to the VMC 50 to inform the VMC 50 of the denomination or credits for the bill at step 134, and the vending machine is placed in an Accept Transaction State “A”.

In the Accept Transaction State “A” the vending machine vends products selected and the VMC 50 determines the amount of change to be dispensed. The VMC 50 sends a signal to the unit controller 78 of the amount of the change to be dispensed and the Control Program 120 determines if coins, bills or a combination of coins and bills are to be dispensed as change.

For vending machines with the NAMA protocol limitation, when the Control Program 120 determines at step 132 that the denomination of the bill received exceeds the capacity of the VMC 50, the Control Program 120 allows the bill acceptor-dispenser 60 to accept higher bill denominations, however, the maximum value of a received note that is communicated to the VMC is, for example, $5 at step 136. The Control Program 120 keeps track of the additional change, or available credit, resulting from the acceptance of a higher bill denomination at step 138 and places the system in the Accept Transaction State “A”.

When the transaction is completed, and the change is to be dispensed, the VMC 50 provides a signal to the bill acceptor-dispenser 60 with the instruction of the value of the amount to be disbursed up to the VMC's limit. The Control Program 120 then determines at step 140 if change is to be dispensed or if another transaction is contemplated. If another transaction is not selected, then the Control Program 120 signals the bill acceptor dispenser 60 which in turn provides an instruction to the coin acceptor/changer 82 to dispense coins and a signal to the VMC 50 indicating that all credits are returned. If necessary, the bill acceptor-dispenser 60 will also dispense notes or currency to make up the balance of the change to be dispensed. In this system, the Control Program 120 controls the communication with the VMC 50 and the logic or selection of the type or types of change to be provided in the form of coins, notes or a combination of coins and notes.

If another transaction is selected at step 140, the Control Program 120 determines at step 144 if sufficient credits or funds are available in the VMC 50 or in the retained credits. If insufficient funds are not available in the VMC 50, then additional credits are transferred from the retained credits to the VMC 50 at step 146 to increase in the VMC 50 the amount of credits. If there are still insufficient funds in the VMC 50 after the retained credits are depleted, then the system dispenses the remaining credits as change. If sufficient credits are available to the VMC 50 at step 144 or after step 146 , then the system effects a transaction at step 148 and cycles to the Accept Transaction State “A”

Thus, the Control Program 120 can also enable the capacity for vending of multiple items before change is dispensed. After an item is dispensed and the remaining credit is calculated, the Control Program 120 can be set to display the balance available for another selection. If the user selects another item, the value of that item is deducted and the new balance is displayed. If the user does not select another transaction or depresses a change dispense button, the appropriate change is dispensed. The Control Program 120 may also be set to wait a specified time for a vend selection and, if no item is selected, the Control Program 120 “times out” and dispenses the appropriate amount of coins or notes as change.

The Control Program 120 is thus configured to recognize when there are special limitations that would impact the benefit of accepting high note denominations. For example, the Control Program 120 accesses the memory 80 of the bill acceptor dispenser 60 to keep track of the number and denomination(s) of notes available in the note hopper 74. If the note hopper 74 is depleted, the Control Program 120 determines if the bill acceptor dispenser 60 should accept higher denominations, i.e. $10 or $20 notes, as only coins may be available to provide change. Thus, the Control Program 120 is capable of instructing the bill acceptor dispenser 60 to limit the denominations that will be accepted until the note hopper 74 is replenished, at which time the capacity to accept higher note denominations is again enabled.

The Control Program 120 is also capable of providing an instruction to the display system 32, located prominently on the vending machine 20 and optionally to a display 66 incorporated into the bezel assembly 38 of the bill acceptor dispenser 60. The Control Program 120 can cause the displays to indicate what note denominations will be accepted in any situation. The Control Program 120 can also cause the displays to indicate the value of a note received, and the available credit before and after an item is selected or vended.

To maximize the ease of implementation of the capacity of the present invention into existing vending machines, the Control Program 120 is preferably incorporated into the bill acceptor dispenser 60. However, the Control Program 120 may alternatively be incorporated into the coin acceptor/dispenser 82 of FIG. 5.

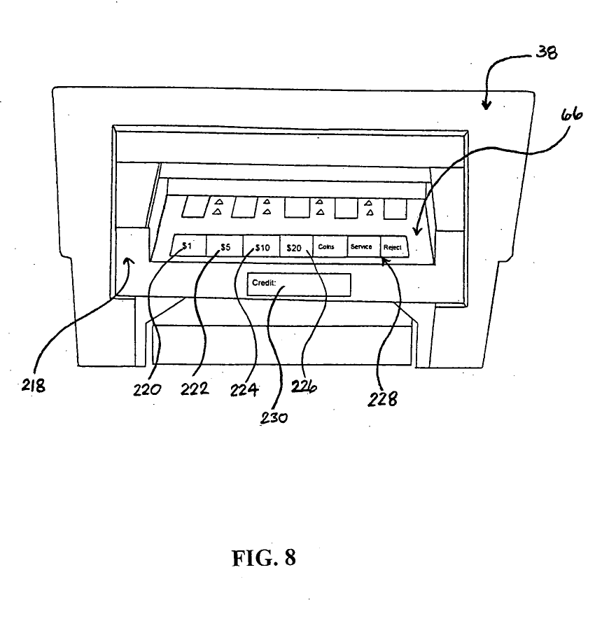

Moreover, since the only portion of the bill acceptor dispenser 60 that is viewable from outside of the vending machine 20 is the bezel assembly 38, a preferred bezel assembly 38 is depicted in FIG. 8. The bezel assembly 38 incorporates a display 66. The display 66 may be an LED display or simply back lighted indicators. The display 66 may also include an enable/disable indicator and separate indicators for each note value that the note acceptor dispenser 60 is accepting. Thus, the display 66 has multiple display indicators on a runway surface 218, including a $1 indicator 220, $5 indicator 222, $10 indicator 224, $20 indicator 226 and optionally a coin, service and /or a reject display 228. The display 66 on the bezel assembly 38 may also include the capability of displaying the amount available as credit following acceptance of a bill via a credit indicator 230. The display 66 of the bezel assembly 38 will be controlled by the Control Program 120 preferably installed on the unit controller.

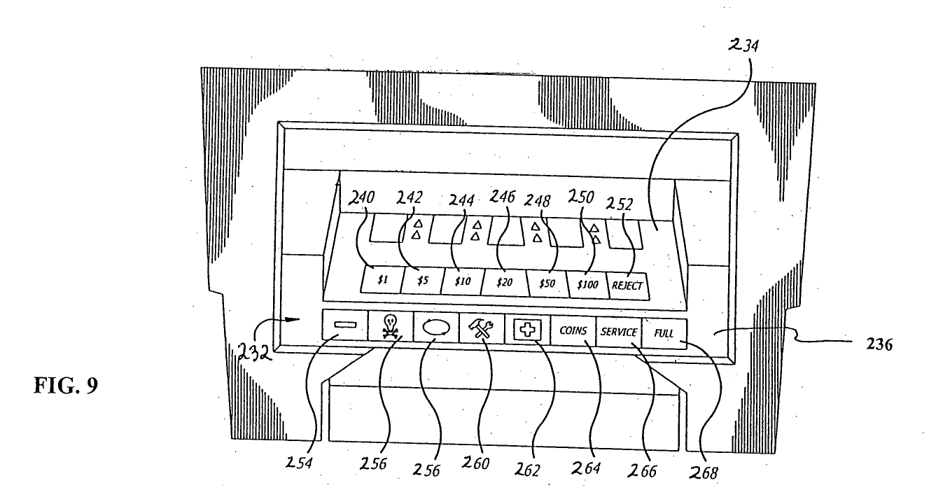

A more advanced version of a bezel assembly 232 is depicted in FIG. 9. As shown in FIG. 9, the enhanced bezel 232 has multiple display indicators on the runway surface 234, including a $1 indicator 240, $5 indicator 242, $10 indicator 244, $20 indicator 246 and optionally a $50 indicator 248 and $100 indicator 250 which illuminate to display the denomination of acceptable notes and, after a note is inserted, illuminate to display the denomination of the note accepted and validated by the bill acceptor-dispenser 60. In addition, the runway surface may have a “reject” indicator 252, to visually display when an unacceptable bill has been inserted and rejected. Additional indicators located on a display surface 236 of the enhanced bezel may include a system lock indicator 254, counterfeit bill indicator 256, transport jam indicator 258 and service indicator 260. The display surface 236 may also include additional indicators for the host machine, such as a diagnostic indicator 262, coin indicator 264, machine service indicator 266 and note box full indicator 268. It should be understood that the various specific display indicators described herein are representative only, and other types of display symbols may be substituted.

For all of the various indicators of the bezel assemblies there are several different methods of displaying the information, for example by back side illumination using, alone or in combination, incandescent lamps, LEDs, electroluminescent emitters, liquid crystals, numeric alphanumeric and graphic displays, and mechanical semaphores. The various indicators are preferably an integral part of a molded or fabricated bill entry piece. Alternatively, the indicators may be separate from the bill acceptor or be part of an associated display panel placed on a display surface of the host machine.

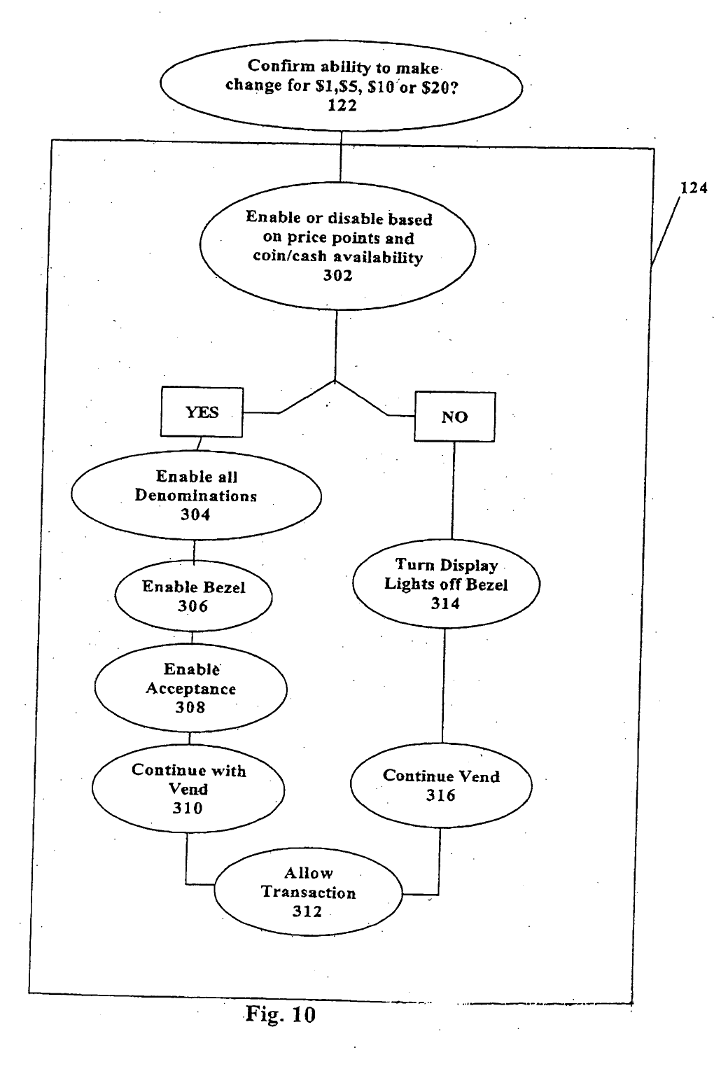

FIG. 10 is a flow chart of a first subroutine for the Control Program of FIG. 7. More specifically, after the step 122 in the Control Program 120 of FIG. 7, the step 124 is illustrated in greater detail. Within step 124, the determination is made to enable or disable acceptance of bills based on price points of the items available to be vended and coin/cash availability at step 302. If it is determined that all bill denominations can be accepted, then the unit controller 78 is instructed enable acceptance of all denominations at step 304. At step 306, the display indicators of the bezel assembly 38 are illuminated for all denominations. At step 308, the validator 62 is enabled to accept all denominations. At step 310, the Control Program 120 allows the continuation of a vending process following acceptance of a bill and completes the transaction, dispensing coins or currency as change if necessary at step 312. If, however, in step 302 it is determined that one or more denominations of bills can not be accepted, then the Control Program provides an instruction at step 314 to the unit controller 78 to turn off selected display indicators on the bezel assembly 38 and the validator 62 is instructed to not accept the selected denominations. Otherwise, the Control Program 120 continues to allow the acceptance of deposits and vending transactions for accepted denominations at step 316 to allow transactions to be completed at step 312, whereupon the system again returns to step 122.

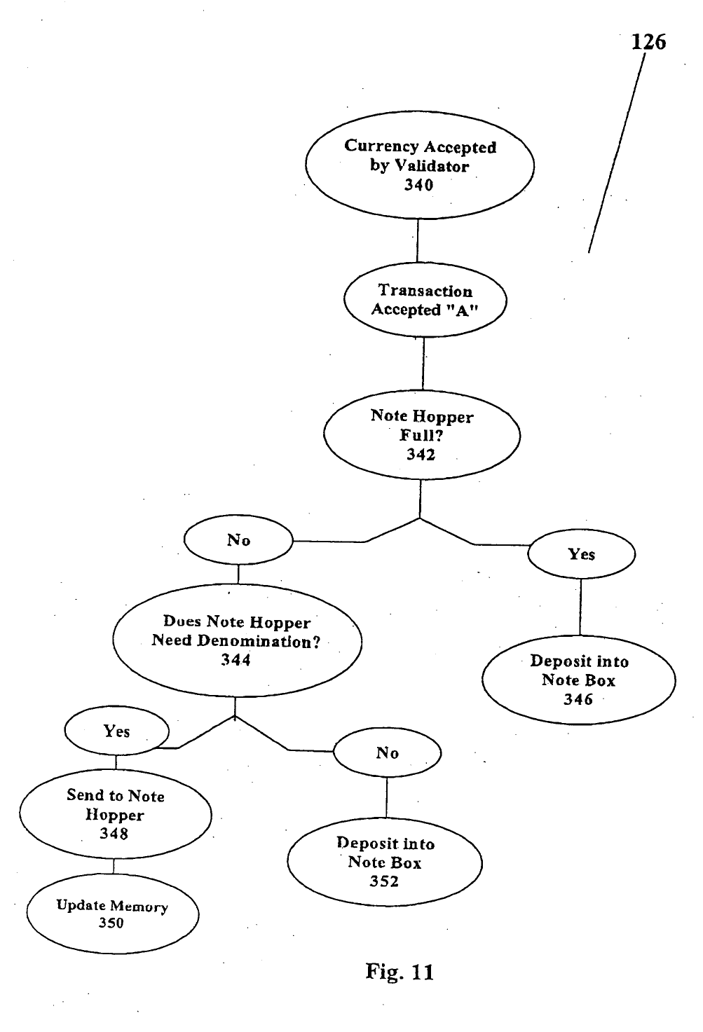

FIG. 11 is a flow chart of a second subroutine for the Control Program of FIG. 7, and more specifically a routine that can be executed at step 126 of FIG. 7, to enable mixed note recycling by the bill acceptor-dispenser 60. Within step 126 of FIG. 7, whenever there is an acceptance of currency by the validator at step 340 and the system is placed into the Accept Transaction State “A”, the Control Program 120 makes an inquiry to the unit controller 78 as to whether the note hopper 74 is full as shown at step 342. If the note hopper 74 is not full, the determination is made at step 344 as to whether the note hopper 74 needs a bill having the denomination that has been received to initiate a transaction. If the note hopper 74 is full, then the decision is made at step 346 to instruct the unit controller 78 that the received bill should be deposited in the note box 72. If at step 344 the determination is made that the note hopper 74 needs the bill, then at step 348 an instruction is sent to the unit controller to direct the bill to the note hopper and the memory 80 is updated at step 350. If at step 344 it is determined that the note hopper 74 does not need the bill, then an instruction is sent to the unit controller 78 to deposit the bill in the note box as shown at step 352.

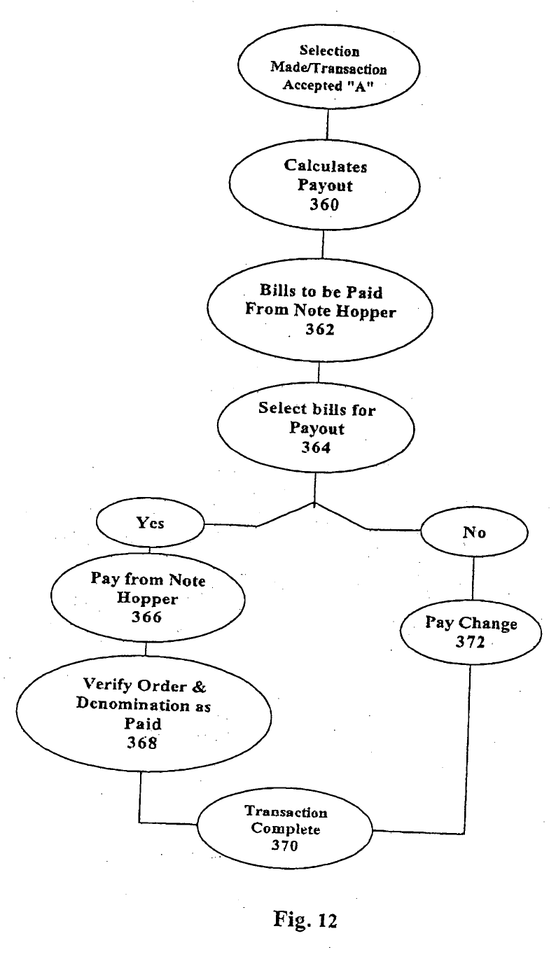

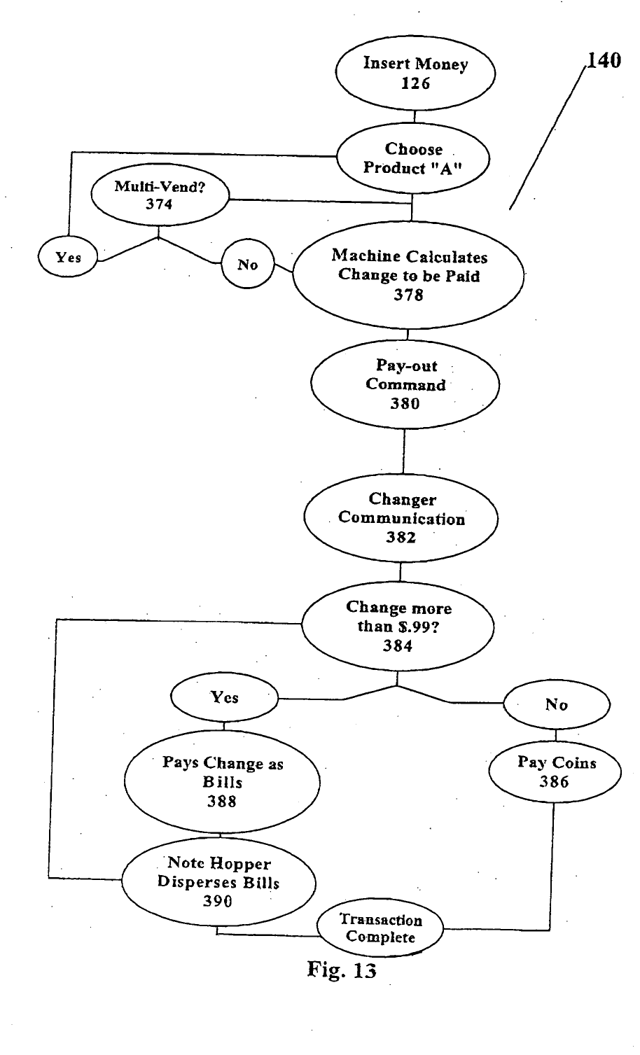

FIG. 12 is a flow chart of a third subroutine for the Control Program of FIG. 7, and more specifically a routine that can be executed to enable a mixed bill payout within the Control Program 120. In this subroutine, once a transaction is accepted and step “A” is completed, the Control Program 120 can calculate a payout at step 360. At step 362, the Control Program 120 determines the optimal combination of bills to pay out of the note hopper 74. For example, if a $20 bill is received and a $2 item is vended, the Control Program 120 first determines that $18 must be paid out and then determines, based on the notes available in the note hopper 74, what combination of notes to pay out at step 364. Using the above example, if sufficient $1 and $5 bills are available, the Control Program 120 can elect to pay out eighteen $1 bills or thirteen $1 bills and one $5 bill or eight $1 bills and two $5 bills or three $1 bills and three $5 bills. The Control Program sends a instruction to payout from the note hopper at step 366. As each bill is extracted from the note hopper, it is verified as to its denomination at step 368 to determine if the particular note should be paid out or routed to the note box as it is not the selected denomination. Once all of the currency sufficient to pay out the remaining credits is dispensed the transaction is completed at step 370. If however, at step 364 it is determined that there are insufficient bills in the note hopper, then an instruction to pay change at step 372 is directed to the coin acceptor/changer which pays out coins to complete the transaction.

FIG. 13 is a flow chart of a fourth subroutine for the Control Program of FIG. 7 to allow the Control Program 120 to determine the optimal payout depending upon the available coins in the coin accepter/changer 82 and bills in the note hopper 74. As discussed above, at step 126 a transaction can be initiated and the system is placed in the Accept Transaction State “A”. After the item is vended, the system determines if a multi vend situation is requested at step 374. If another vend is requested, the system returns to “A”. If after step “A” there is insufficient credits to allow further vending or insufficient product to be vended, or after step 374 another vending request is not submitted, then at step 378 the system calculates the change to be paid and the optimal combination of coins and/or bills to be paid in order to optimizes the remaining available change for a subsequent transaction. Based on an optimization determination, the unit controller 78 and VMC 50 are instructed at step 380 to cause the payout of the determined combination of coins, bills and/or coins and bills. At step 382, the instructions are sent to the note hopper 74 and coin acceptor/changer 82 to cause the pay out of the selected change. If the amount of change is greater than $0.99, an instruction preferably causes change to pay out as bills from the note hopper 74 at step 388. After the note hopper dispenses a bill and it is validated as it is dispensed at step 390, a signal routes back to step 384 at which point the determination is again made as to the remaining amount to be pay out. One the amount is less than $0.99, then the balance is paid out in coins at step 386 and the transaction is completed.

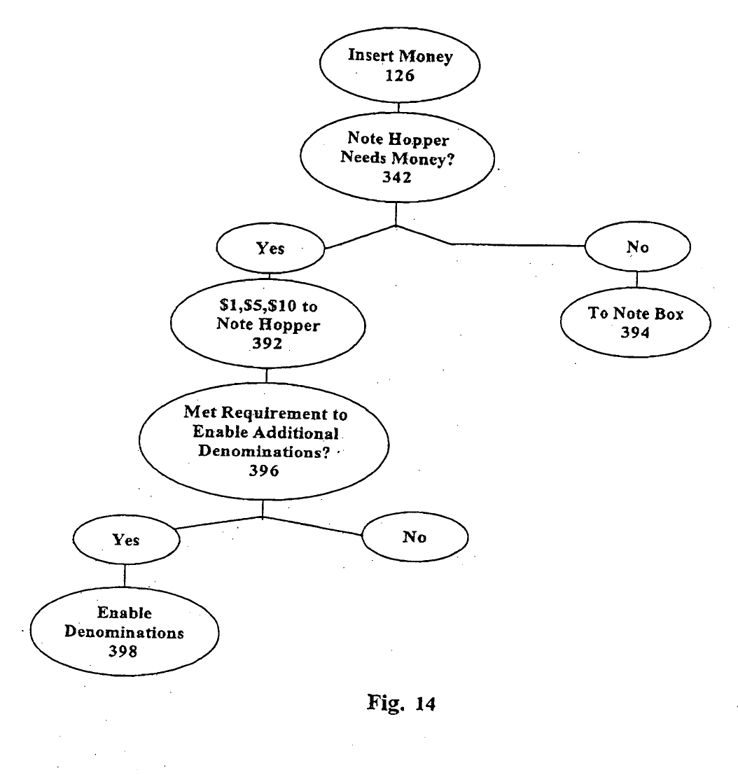

FIG. 14 is a flow chart of a fifth subroutine for the Control Program of FIG. 7 as an alternative control of the displays. As above, the transaction starts at step 126. The determination is then made as to whether the note hopper needs money at step 342. If the note hopper needs to be replenished, at step 392 bills having denominations of $1, $5 and/or $10 are directed to the note hopper 74. However, if at step 342 the determination is made that the note hopper does not need to be replenished, then the bill is directed to the note box at step 394. When bills are sent to the note hopper at step 392, the determination is made at step 396 as to whether the addition of the note to the note hopper will allow additional denominations of notes to be accepted. For example, if the note hopper only has $6 in notes the Control Program 120 will not allow the acceptance of a $20 bill. If, however, a $10 bill is accepted and routed to the note hopper 74, then at step 396 the determination can be made to allow acceptance of a $20 bill and at step 398 additional denominations are enabled both at the validator 62 and on the display indicators of the bezel assembly 38

To further increase the capabilities of the vending machines ability to accept various denominations of notes and dispense change, the bill acceptor dispenser 60 can be configured to escrow and dispense multiple denominations from the note hopper 74. For example, the note hopper 74 may be enabled to escrow $1, $5 and even $10 notes. A note escrow program in the bill acceptor dispenser 60 will keep track of at least the total value of escrowed notes in the note hopper 74. Preferably, the note escrow program will keep track of or even control the order, by number and denomination, of notes in the note hopper 74. For example, the note escrow program will cause the bill acceptor dispenser 60 to escrow five one dollar bills and then one five dollar bill in a repetitive pattern. In the event that the bill being retrieved from the note hopper 74 is not the correct denomination selected to be dispensed as change, the transportation unit 70 is directed to route the note to the note box 72. Alternatively, the bill acceptor dispenser 60 can validate each note to be dispensed to determine if it has a value selected to be dispensed as change. If a note retrieved from the note hopper 74 is not of the selected denomination it is routed to the note box 72 and the next available note from the note hopper 74 is retrieved and validated.

The present invention thus provides an intelligent currency handling system for a vending machine. The invention allows the retrofit of existing vending machines operating a NAMA protocol to accommodate higher denominations of notes, the dispensing of correct change in the form of coins, currency or a combination of coins and currency, and the potential to emulate the preferred selection of notes provided as change that would be provided by a human operator.

While the foregoing description is provided to detail an exemplary embodiment of the present invention, it will be appreciated by those skilled in the art that many other variations and advantages of the present invention are enabled. Accordingly, the scope of the invention is to be limited only by the proper interpretation of the following claims.

What is claimed is:

1. A vending machine for vending products including the vending machine comprising:
a cabinet and a door defining an inner cavity for holding products for vending;
a vending machine controller (“VMC”) for controlling the operation of the vending machine based on a standardized vending machine protocol program;
a money handling system including a coin acceptor/changer and a bill acceptor-dispenser for receiving and dispensing money;
said bill acceptor-dispenser including:
a validator for determining the authenticity and denomination, of notes inserted into said bill acceptor-dispenser and for generating signals for each received note;
a processor for receiving the validator signals and communicating with to said VMC;
a note box configured to receive and hold notes received by said bill acceptor-dispenser;
a note hopper for escrowing notes received by said bill acceptor-dispenser; and
a transportation unit for directing notes determined to be authentic to one of said note box and said note hopper and for dispensing notes from said note hopper;
said coin acceptor/changer receiving and validating coins and generating a signal signifying receipt and value of received coins to said VMC; and
a program to calculate change to be dispensed by the vending machine and outputting signals indicative of the change to be dispensed to said bill acceptor-dispenser which controls the disbursement of currency and coins by said vending machine.

2. The vending machine of claim 1 wherein said bill acceptor-dispenser further comprises:
a memory for maintaining a running accounting of the number and denominations of the notes contained in said note hopper.

3. The vending machine of claim 1 wherein said bill acceptor-dispenser further comprises:
a unit controller for controlling the operation of the bill acceptor-dispenser, said unit controller being capable of changing the characteristic used for directing notes to said note hopper.

4. The vending machine of claim 1, further comprising:
a processor for calculating the number of notes to be dispensed from said note hopper and the number of coins to be dispensed from said coin hopper to provide a combination of notes and coins to total an amount to be dispensed following the vending of an item.

5. The vending machine of claim 4 wherein said processor runs a Control Program, said Control Program being capable of communicating with the VMC and controlling the display of information to a user.

6. The note acceptor-dispenser of claim 5 further comprising a controller for controlling the disbursement of currency and coins from said vending machine.

7. A bill acceptor-dispenser for receiving and dispensing money in a vending machine having a vending machine controller (“VMC”) for controlling the operation of the vending machine based on a standardized vending machine protocol program and a coin acceptor/changer for receiving and validating coins and generating a signal signifying receipt and value of received coins to the VMC;
the bill acceptor-dispenser comprising:
a validator for sensing data relating to the authenticity, denomination, and type of note inserted into said validator and for generating signals corresponding to the sensed data for each received note;
a processor for receiving and comparing said sensed data signals with stored data to validate the authenticity of said notes and for generating a signal signifying receipt and a designated value of said note within the limitations of the standardized protocol to said VMC;
a note box configured to receive and hold notes received by said bill acceptor-dispenser;
a note hopper for escrowing notes received by said bill acceptor-dispenser; and
a transportation unit for directing said notes determined to be authentic to one of said note box and said note hopper and for dispensing notes from said note hopper in response to a signal from said processor.

8. A vending machine comprising:
a cabinet for storing items to be vended;
a coin acceptor/changer for accepting and validating coins and dispensing coins as change upon command;
a bill acceptor-dispenser for accepting and validating notes, storing selected notes in a dispensable fashion and storing all other received notes in a non-dispensable fashion, said bill acceptor-dispenser controlling the dispensing of coins and notes as change provided by said vending machine; and
a Control Program for controlling the denominations of notes to be accepted by said bill acceptor-dispenser based upon the availability of notes held in a dispensable fashion.

9. The vending machine of claim 8 wherein said bill acceptor-dispenser further comprises:
a bezel assembly having an opening for allowing the insertion of notes into said bill acceptor-dispenser, said bezel assembly also having a display to provide a visual indication of the denominations of notes that said Control Program will allow to be accepted.
